(19) United States
(12) Patent Application Publication
(10) Pub. No.: US 2024/0384025 A1
(43) Pub. Date: Nov. 21, 2024

(54) A THERMALLY CURABLE EPOXY SYSTEM

(71) Applicant: ADITYA BIRLA CHEMICALS (THAILAND) LIMITED (ADVANCED MATERIALS), Rayong (TH)

(72) Inventors: Pradip Kumar DUBEY, Rayong (TH); Amit DIXIT, Rayong (TH); Sirirat CHANGMONGKOL, Rayong (TH); Atchara CHADSIRIWATTANA, Rayong (TH); Sarun RUNGRUANGSUPARAT, Rayong (TH)

(21) Appl. No.: 18/564,926

(22) PCT Filed: May 31, 2022
(86) PCT No.: PCT/IB2022/055079

§ 371 Date: Nov. 28, 2023

(30) Foreign Application Priority Data
May 31, 2021 (IN) 202111024247

(51) Int. Cl. C08G 59/68; C08L 83/10

(52) U.S. Cl. CPC C08G 59/682; C08L 83/10

(57) ABSTRACT

A thermally curable epoxy system includes 94 to 99.98 wt % of an epoxide component, 0.01 to 5% wt% of a toughener, 0.005 to 1.5 wt % of a catalyst, and 0.005 to 1.5 wt % of a co-catalyst.

### FIELD OF INVENTION

The present disclosure relates to a thermally curable epoxy system. Particularly, the disclosure relates to an anhydride free, 1K epoxy system which when cured exhibits improved hydrolytic stability, and crack resistance.

### BACKGROUND

Curing of epoxy resin, especially bisphenol A diglycidyl ether with anhydrides is well known and widely used for application in various industries. Specifically, epoxy-anhydride systems are used as polymeric insulating materials for industrial applications in the field of electrical casting, potting, and encapsulation to manufacture components such as insulators, bushings, transformers, switchgear components, power generators, etc.

However, the anhydrides commonly used for the curing of epoxy resin are hazardous to health. Therefore, certain anhydrides are already on the Substances of Very High Concern (SVHC) Candidate list regulated by registration, evaluation, authorization, and restriction of chemicals (REACH), while others are also facing resistance.

Attempts have been made to avoid the use of anhydride for curing of epoxy resin by employing specific catalyst and co-catalyst combinations as curing agents. However, such epoxy systems exhibit poor hydrolytic stability and susceptibility to cracking.

### SUMMARY

A thermally curable epoxy system is disclosed. Said epoxy system comprises of 94 to 99.98 wt % of an epoxide component, 0.01 to 5% wt % of a toughener, 0.005 to 1.5 wt % of a catalyst, and 0.005 to 1.5 wt % of a co-catalyst.

### BRIEF DESCRIPTION OF DRAWINGS

FIG. 1, including FIGS. 1(a) and 1(b), shows a comparison of a conventional epoxy system, COMP1 (1A) and cured matrix of a thermally curable epoxy system, INV1 (1B) prepared in accordance with an embodiment of present disclosure, after hydrolytic stability-pressure cooker test.

FIG. 2, including FIGS. 2(a) and 2(b), shows a comparison of a conventional epoxy system, COMP2 (2A) and cured matrix of a thermally curable epoxy system, INV2 (2B) prepared in accordance with an embodiment of present disclosure, after hydrolytic stability-pressure cooker test.

FIG. 3, including FIGS. 3(a) and 3(b), shows a comparison of a conventional epoxy system, COMP3 (3A) and cured matrix of a thermally curable epoxy system, INV3 (3B) prepared in accordance with an embodiment of present disclosure, after hydrolytic stability-pressure cooker test.

FIG. 4, including FIGS. 4(a) and 4(b), shows a comparison of cured matrix of a conventional epoxy system, COMP4 (4A) and thermally curable epoxy system, INV4 (4B) prepared in accordance with an embodiment of present disclosure, after hydrolytic stability-pressure cooker test.

FIG. 5, including FIGS. 5(a) and 5(b), shows a comparison of a conventional epoxy system, COMP5 (5A) and cured matrix of a thermally curable epoxy system, INV5 (5B) prepared in accordance with an embodiment of present disclosure, after hydrolytic stability-pressure cooker test.

FIG. 6, including FIGS. 6(a) and 6(b), shows a comparison of a conventional epoxy system, COMP6 (6A) and cured matrix of a thermally curable epoxy system, INV6 (6B) prepared in accordance with an embodiment of present disclosure, after hydrolytic stability-pressure cooker test.

### DETAILED DESCRIPTION

For the purpose of promoting an understanding of the principles of the disclosure, reference will now be made to embodiments and specific language will be used to describe the same. It will nevertheless be understood that no limitation of the scope of the disclosure is thereby intended, such alterations and further modifications in the disclosed composition and method, and such further applications of the principles of the disclosure therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “one embodiment” “an embodiment” or similar language means that a particular feature, structure, or characteristic described in connection with the embodiment is included in at least one embodiment of the present disclosure. Thus, appearances of the phrase “in one embodiment”, “in an embodiment” and similar language throughout this specification may, but do not necessarily, all refer to the same embodiment.

The terms “comprise”, “comprising”, or any other variations thereof, are intended to cover a non-exclusive inclusion and are not intended to be construed as “consists of only”, such that a process or method that comprises a list of steps does not include only those steps but may include other steps not expressly listed or inherent to such process or method.

Likewise, the terms “having” and “including”, and their grammatical variants are intended to be non-limiting, such that recitations of said items in a list are not to the exclusion of other items that can be substituted or added to the listed items.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

In its broadest scope, the present disclosure relates to a thermally curable epoxy system which are anhydride free. Specifically, the present disclosure relates to a thermally curable epoxy system comprising of 94 to 99.98 wt % of an epoxide component, 0.01 to 5% wt % of a toughener, 0.005 to 1.5 wt % of a catalyst, and 0.005 to 1.5 wt % of a co-catalyst.

In accordance with an embodiment, the epoxide component comprises one or more of a di- and poly-epoxide compound comprising a moiety selected from the group consisting of aliphatic. cycloaliphatic, and aromatic groups. In some embodiments, the epoxide component is selected from the group consisting of bisphenol A diglycidyl ether, bisphenol F diglycidyl ether, phenol novolac epoxy resin, cyclohexanedimethanol diglycidyl ether, neopentyl glycol diglycidyl ether, dipropylene glycol diglycidyl ether, 3,4-epoxycyclohexylmethyl 3,4-epoxycyclohexane carboxylate and combinations thereof. The amount of epoxide component may vary depending on the application of the epoxy system.

In an embodiment, the toughener is a linear block copolymer having formula 1:

$${A}^{″} - B - {A}^{′} \qquad ( 1 )$$

wherein B is an organosiloxane block and A′or A″ is a polycaprolactone block. In an embodiment, the thermally curable epoxy system comprises the toughener in an amount of 0.5 to 2 wt %.

In an embodiment, the catalyst is one or more aromatic iodonium salt of fluorometallate anions. The fluorometallate anions are selected from the group consisting of [SbF₆]⁻, [BF₄]⁻, [PF₆]⁻ and [AsF₆]⁻. In some embodiments, the catalyst is selected from the group consisting of (4-octyloxyphenyl) (phenyl) iodonium hexafluoroantimonate (IOC-8 SbF₆), (4-isopropylphenyl)-(p-tolyl) iodonium tetrakis (perfluorophenyl) borate (IPTI-PFPB), diphenyliodonium tetrafluoroborate and diphenyliodonium hexafluorophosphate. In an embodiment, the thermally curable epoxy system comprises the catalyst in an amount of 0.01 to 0.4 wt %.

In an embodiment, the co-catalyst is benzopinacol or a derivative thereof. In some embodiments, the benzopinacol derivative is selected from the group consisting of benzopinacolone, benzopinacol-bis (trimethylsilyl ether), benzopinacol dimethyl ether, 1,1,2,2-tetraphenylethane and combinations thereof. In accordance with an embodiment, the thermally curable epoxy system comprises the co-catalyst in an amount of 0.02 to 0.6 wt %.

In the disclosed thermally curable epoxy system, curing is carried out by radical-induced cationic polymerization. Upon heating, the co-catalyst generates reactive radicals which on their parts are able to subsequently cleave with specified catalysts to form complexes. The complexes further react with monomer to form polymer and liberate heat due to exothermic reaction. The heat liberated is consumed by the co-catalyst and the reactive radicals drive the polymerization further. The radical induced cationic polymerization reaction occurring in disclosed epoxy system is illustrated below:

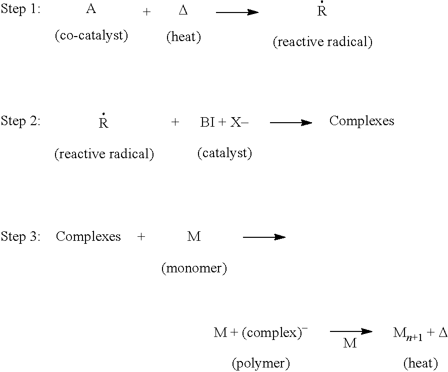

A method for preparing the disclosed thermally curable epoxy resin is also disclosed. Said method comprises the steps of:
(a) mixing catalyst, co-catalyst and a solvent to obtain a solution of catalyst and co-catalyst,
(b) preparing epoxide component by heating upto 50 to 60° C. for a predetermined time period;
(c) mixing the solution of catalyst and co-catalyst obtained in step (a) with the epoxide component prepared in step (b);
(d) causing the removal of solvent from the mixture obtained in step (c);
(e) adding toughener to the mixture obtained in step (d), followed by mixing of the resultant mixture at a temperature ranging between 80 to 100° C., till a homogeneous mixture is obtained; and
(f) curing the mixture in step (d) or (e).

In an embodiment, in step (a), the mixing is carried out at room temperature until both catalyst and co-catalyst dissolve in the solvent.

In an embodiment, in step (c), the mixing is carried out at a temperature ranging between 50 to 70° C. for 60 minutes to 2 hours. In some embodiments, the mixing is carried at 50° C. for 60 minutes.

In an embodiment, in step (d), solvent removal is carried out in a vacuum oven by heating the mixture at 50 to 70° C. for 2 to 6 hours. In some embodiments, the heating is carried at 50° C. for 4 hours.

In an embodiment, in step (e), after the addition of toughener, the resultant mixture is mixed for 30 to 90 minutes. In some embodiments, the resultant mixture is mixed for 60 minutes. In an embodiment, after obtaining a homogeneous mixture, this mixture is cooled to ambient temperature.

In an embodiment, radical induced cationic polymerization is initiated by curing at an elevated temperature. In an embodiment, the curing is carried out at a temperature in a range of 100-150° C. for a predetermined time period. In some embodiments, the curing is carried out in multiple steps. In an exemplary embodiment, curing is carried out at 100° C. for 2 hours, followed by curing at 120° for 2hours, and then at 140° C. for 10 hours.

### EXAMPLES

In order that this invention may be better understood, the following examples are set forth. These examples are for the purpose of illustration only and the exact compositions, methods of preparation and embodiments shown are not limiting of the invention, and any obvious modifications will be apparent to one skilled in the art.

Also described herein are methods for characterizing the epoxy system, formed using embodiments of the claimed process.

### Characterizing Methods

1. Hydrolytic stability of cured matrix was measured using pressure cooker test, after conditioning @96 hrs./2 bar @120° C.
2. Latency was measured by measuring viscosity built up with time.

### Example 1: Comparison of Exemplary Epoxy System with Conventional Epoxy Systems

An exemplary epoxy system (INV1) was prepared by mixing the epoxy component, toughener, catalyst and co-catalyst. A conventional epoxy system (COMP1) was prepared by mixing the epoxy component, anhydride curing agent and an amine catalyst. Table 1 provides the composition of INV1 and COMP 1.

TABLE 1
Composition of COMP1 and INV1

| Composition (weight, in grams) | COMP 1 | INV1 |
|---|---|---|
| Bisphenol A diglycidyl ether | 49.75 | 98 |
| Neopentyl glycol diglycidyl ether | — | 1 |
| Polycaprolactone-Polysiloxane Block Copolymer | — | 1 |
| IOC-8 SbF₆ | — | 0.4 |
| Benzopinacol | — | 0.6 |
| Anhydride Curing Agent | 49.75 | — |
| Amine Catalyst | 0.5 | — |
| Total weight of formulation | 100 | 101 |

INV1 and COMP1 were cured under curing condition: 100° C./2 hours+120° C./2 hours+140° C./10 hours.

The latency of INV1 and COMP1 was measured. Also, the mechanical properties of the cured samples of INV1 and COMP1 were assessed.

Results and Observation: It was observed that INV1 exhibited low viscosity build up, as compared to COMP1.

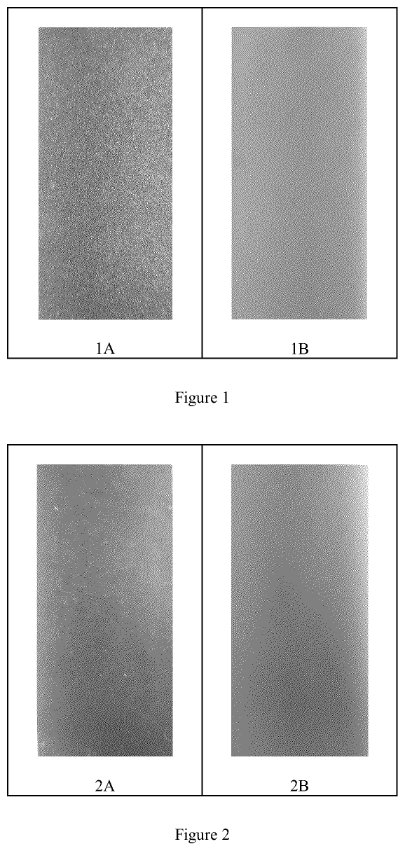

FIG. 1 shows a comparison of cured matrix of COMP1 (1A) and INV1 (1B), after hydrolytic stability pressure cooker test at 96 hours, 2 bar/120° C. It was observed that cured matrix of COMP1 had a lot of micro-cracks, whereas cured matrix of INV1 did not have micro-cracks and exhibited improved thermal crack resistance and hydrolytic stability.

Table 2 summarizes the results of latency measurements and mechanical properties of both INV1 and COMP1.

TABLE 2
Properties of COMP1 and INV1

| | | |
|---|---|---|
| Properties | COMP1 | INV1 |

| | | | |
|---|---|---|---|
| % viscosity increase | 25° C., 8 days | >100% | 0.8% |
| after storage | 40° C., 8 days | Mass | 3.7% |
| | | gelled | |

| | | Test | | |
|---|---|---|---|---|
| Processing properties | unit | method | | |
| Viscosity @25° C. | MPa | ASTM D | 2.163 | 4.568 |
| Viscosity @25° C. | | 2196-05 | 5.326 | 4.603 |
| after 25° C./8 days | | | | |
| Viscosity increase | % | | 146.23 | 0.77 |
| after 25° C./8 days | | | | |
| Viscosity @40° C. | MPa | | 342 | 779 |
| Viscosity @40° C. | | | Gel | 808 |
| after 40° C./8 days | | | | |
| Viscosity increase | % | | — | 3.72 |
| after 40° C./8 days | | | | |
| Gel time | minutes | DIN | | |
| @ 100° C. | | 16945 | 19:32 | 146:42 |
| @ 140° C. | | | 3:43 | 3:58 |

| Performance Property | | Test | | |
|---|---|---|---|---|
| of cured system | unit | method | COMP1 | INV1 |
| Water Absorption, | % | ISO 62 | 0.11 | 0.04 |
| 25° C./24 hours | | | | |
| Dielectric strength | kV/mm | IEC | 19.33 | 21.41 |
| | | 60243 | | |
| Pressure cooker test | | | Cracks | No |
| (PCT) at 120° C./ | | | seen | Cracks |
| 2 mbar/96 hrs | | | | seen |
| (Thickness 2 mm) | | | | |

### Example 2: Comparison of Exemplary Epoxy System with Epoxy Systems Prepared without Toughener

An exemplary epoxy system (INV2) was prepared by mixing the epoxy component, toughener, catalyst and co-catalyst. A conventional epoxy system (COMP2) was prepared by mixing the epoxy component, catalyst and co-catalyst. Table 3 provides the composition of INV2 and COMP2.

TABLE 3
Composition of COMP2 and INV2

| Composition (weight, in grams) | COMP2 | INV2 |
|---|---|---|
| phenol novolac epoxy resin | 99.71 | 99.42 |
| Polycaprolactone-polysiloxane Block Copolymer | — | 1 |
| IOC-8 SbF₆ | 0.12 | 0.24 |
| Benzopinacol | 0.17 | 0.34 |
| Total weight of formulation | 100 | 101 |

INV2 and COMP2 were cured under curing condition: 100° C./2 hours+120° C./2 hours+140° C./10 hours.

The latency of INV2 and COMP2 was measured. Also, the mechanical properties of the cured samples of INV2 and COMP2 were assessed.

Results and Observation: It was observed that INV2 exhibited low viscosity build up, as compared to COMP2.

FIG. 2 shows a comparison of cured matrix of COMP2 (2A) and INV2 (2B), after hydrolytic stability pressure cooker test at 96 hours, 2 bar/120° C. It was observed that cured matrix COMP2 had a lot of micro-cracks, whereas cured matrix of INV2 did not have micro-cracks and exhibited improved thermal crack resistance and hydrolytic stability.

Table 4 summarizes the results of latency measurements and mechanical properties of both INV2 and COMP2.

TABLE 4
Properties of INV2 and COMP2

| Properties | | COMP2 | INV2 |
|---|---|---|---|
| % Viscosity increase | 25° C., 8 days | — | — |
| after storage | 40° C., 8 days | 8.0% | 7.1% |

| | | Test | | |
|---|---|---|---|---|
| Processing properties | unit | method | | |
| Viscosity @25° C. | MPa | ASTM D | >1,600,000 | >1,600,000 |
| Viscosity @25° C. | | 2196-05 | >1,600,000 | >1,600,000 |
| after 25° C./8 days | | | | |
| Viscosity increase | % | | — | — |
| after 25° C./8 days | | | | |
| Viscosity @40° C. | MPa | | 95,260 | 1,20,960 |
| Viscosity @40° C. | | | 1,02,900 | 1,29,600 |
| after 40° C./8 days | | | | |
| Viscosity increase | % | | 8.02 | 7.14 |
| after 40° C./8 days | | | | |
| Gel time | minutes | DIN | | |
| @ 100° C. | | 16945 | 120:30 | 233:51 |
| @ 140° C. | | | 4:09 | 3:48 |

| Performance Property | | Test | | |
|---|---|---|---|---|
| of cured system | unit | method | COMP2 | INV2 |
| Water Absorption, | % | ISO 62 | 0.10 | 0.06 |
| 25° C./24 hours | | | | |
| Dielectric strength | kV/mm | IEC | 21.75 | 20.2 |
| | | 60243 | | |
| Pressure cooker test | | | Cracks | No |
| (PCT) at 120° C./ | | | seen | cracks |
| 2 mbar/96 hrs | | | | seen |
| (Thickness 2 mm) | | | | |

It was observed that INV2 exhibited low viscosity build up, as compared to COMP2. Additionally, INV2 was found to exhibit improved mechanical properties as compared to COMP2.

### Example 3: Comparison of Exemplary Epoxy System with Epoxy Systems Prepared without Toughener

An exemplary epoxy system (INV3) was prepared by mixing the epoxy component, toughener, catalyst and co-catalyst. A conventional epoxy system (COMP3) was prepared by mixing the epoxy component, catalyst and co-catalyst. Table 5 provides the composition of INV3 and COMP3.

TABLE 5
Composition of INV3 and COMP3

| Composition (weight, in grams) | COMP3 | INV3 |
|---|---|---|
| 3,4-epoxycyclohexylmethyl 3,4-epoxycyclohexane | 99.97 | 99.88 |
| carboxylate | | |
| Polycaprolactone-polysiloxane Block Copolymer | — | 1 |
| IOC-8 SbF₆ | 0.01 | 0.05 |
| Benzopinacol | 0.02 | 0.07 |
| Total weight of formulation | 100 | 101 |

INV3 and COMP3 were cured under curing condition: 100° C./2 hours+120° C./2 hours+140° C./10 hours.

The latency of INV3 and COMP3 was measured. Also, the mechanical properties of the cured samples of INV3 and COMP3 were assessed.

Results and Observation: It was observed that INV3 exhibited low viscosity build up, as compared to COMP3.

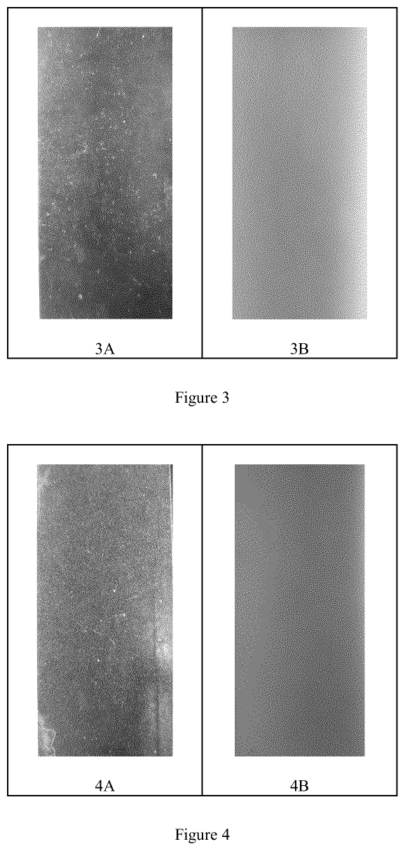

FIG. 3 shows a comparison of cured matrix of COMP3 (3A) and INV3 (3B), after hydrolytic stability pressure cooker test at 96 hours, 2 bar/120° C. It was observed that cured matrix COMP3 had a lot of micro-cracks, whereas cured matrix of INV3 did not have micro-cracks and exhibited improved thermal crack resistance and hydrolytic stability.

Table 6 summarizes the results of latency measurements and mechanical properties of both INV3 and COMP3.

TABLE 6
Properties of COMP3 and INV3

| | | |
|---|---|---|
| Properties | COMP3 | INV3 |

| | | | |
|---|---|---|---|
| % Viscosity increase | 25° C., 8 days | 3.8% | 0.5% |
| after storage | 40° C., 8 days | 4.4% | 1.4% |

| | | Test | | |
|---|---|---|---|---|
| Processing properties | unit | method | | |
| Viscosity @25° C. | MPa | ASTM D | 210 | 406 |
| Viscosity @25° C. | | 2196-05 | 218 | 408 |
| after 25° C./8 days | | | | |
| Viscosity increase | % | | 3.81 | 0.49 |
| after 25° C./8 days | | | | |
| Viscosity @40° C. | MPa | | 113 | 144 |
| Viscosity @40° C. | | | 118 | 146 |
| after 40° C./8 days | | | | |
| Viscosity increase | % | | 4.42 | 1.39 |
| after 40° C./8 days | | | | |
| Gel time | minutes | DIN | | |
| @ 100° C. | | 16945 | 73 | >240 |
| @ 140° C. | | | 7:20 | 27:11 |

| Performance Property | | Test | | |
|---|---|---|---|---|
| of cured system* | unit | method | COMP3 | INV3 |
| Water Absorption, | % | ISO 62 | 0.31 | 0.15 |
| 25° C./24 hours | | | | |
| Dielectric strength | kV/mm | IEC | 18.5 | 17.6 |
| | | 60243 | | |
| Pressure cooker test | | | Cracks | No |
| (PCT) at 120° C./ | | | seen | cracks |
| 2 mbar/96 hrs | | | | seen |
| (Thickness 2 mm) | | | | |

### Example 4: Comparison of Exemplary Epoxy System with Epoxy Systems without Toughener

An exemplary epoxy system (INV4) was prepared by mixing the epoxy component, toughener, catalyst and co-catalyst. A conventional epoxy system (COMP4) was prepared by mixing the epoxy component, catalyst and co-catalyst. Table 7 provides the composition of INV4 and COMP4.

TABLE 7
Composition of COMP4 and INV4

| Composition (weight, in grams) | COMP4 | INV4 |
|---|---|---|
| Bisphenol A diglycidyl ether | 99 | 99 |
| Polycaprolactone-polysiloxane Block Copolymer | — | 1 |
| IOC-8 SbF₆ | 0.4 | 0.4 |
| Benzopinacol | 0.6 | 0.6 |
| Total weight of formulation | 100 | 101 |

INV4 and COMP4 were cured under curing condition: 100° C./2 hours+120° C./2 hours+140° C./10 hours.

The latency of INV4 and COMP4 was measured. Also, the mechanical properties of the cured samples of INV4 and COMP4 were assessed.

Results and Observation: It was observed that INV4 exhibited low viscosity build up, as compared to COMP4.

FIG. 4 shows a comparison of cured matrix of COMP4 (4A) and INV4 (4B), after hydrolytic stability pressure cooker test at 96 hours, 2 bar/120° C. It was observed that cured matrix of COMP4 had a lot of micro-cracks, whereas cured matrix of INV4 did not have micro-cracks and exhibited improved thermal crack resistance and hydrolytic stability.

Table 8 summarizes the results of latency measurements and mechanical properties of both INV4 and COMP4.

TABLE 8
Properties of COMP4 and INV4

| | | |
|---|---|---|
| Properties | COMP4 | INV4 |

| | | | |
|---|---|---|---|
| % viscosity increase | 25° C., 8 days | 0.6% | 1.3% |
| after storage | 40° C., 8 days | 5.1% | 4.1% |

| | | Test | | |
|---|---|---|---|---|
| Processing properties | unit | method | | |
| Viscosity @25° C. | MPa | ASTM D | 5.042 | 5.339 |
| Viscosity @25° C. | | 2196-05 | 5.072 | 5.406 |
| after 25° C./8 days | | | | |
| Viscosity increase | % | | 0.60 | 1.25 |
| after 25° C./8 days | | | | |
| Viscosity @40° C. | MPa | | 819 | 890 |
| Viscosity @40° C. | | | 861 | 926 |
| after 40° C./8 days | | | | |
| Viscosity increase | % | | 5.13 | 4.14 |
| after 40° C./8 days | | | | |
| Gel time | minutes | DIN | | |
| @ 100° C. | | 16945 | 13:48 | 198 |
| @ 140° C. | | | 2:10 | 5 |

| Performance Property | | Test | | |
|---|---|---|---|---|
| of cured system | unit | method | COMP4 | INV4 |
| Water Absorption, | % | ISO 62 | 0.13 | 0.05 |
| 25° C./24 hours | | | | |
| Dielectric strength | kV/mm | IEC | 22.34 | 21.36 |
| | | 60243 | | |
| Pressure cooker test | | | Cracks | No |
| (PCT) at 120° C./ | | | seen | Cracks |
| 2 mbar/96 hrs | | | | seen |
| (Thickness 2 mm) | | | | |

### Example 5: Comparison of Exemplary Epoxy System with Epoxy Systems Prepared without Toughener

An exemplary epoxy system (INV5) was prepared by mixing the epoxy component, toughener, catalyst and co-catalyst. A conventional epoxy system (COMP5) was prepared by mixing the epoxy component, catalyst and co-catalyst. Table 9 provides the composition of INV5 and COMP5.

TABLE 9
Composition of COMP5 and INV5

| Composition (weight, in grams) | COMP5 | INV5 |
|---|---|---|
| Bisphenol F diglycidyl ether | 99.1 | 99.1 |
| Polycaprolactone-polysiloxane Block Copolymer | — | 1 |
| IOC-8 SbF₆ | 0.4 | 0.4 |
| Benzopinacol | 0.5 | 0.5 |
| Total weight of formulation | 100 | 101 |

INV5 and COMP5 were cured under curing condition: 100° C./2 hours+120° C./2 hours+140° C./10 hours.

The latency of INV5 and COMP5 was measured. Also, the mechanical properties of the cured samples of INV5 and COMP5 were assessed.

Results and Observation: It was observed that, INV5 exhibited low viscosity build up, as compared to COMP5. Additionally, INV5 was found to exhibit improved mechanical properties as compared to COMP5.

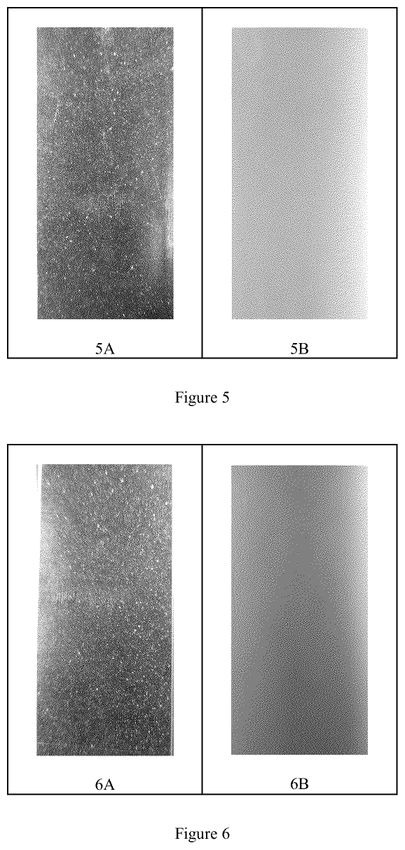

FIG. 5 shows a comparison of cured matrix of COMP5 (5A) and INV5 (5B), after hydrolytic stability pressure cooker test at 96 hours, 2 bar/120° C. It was observed that cured matrix COMP5 had a lot of micro-cracks, whereas cured matrix of INV5 did not have micro-cracks and exhibited improved thermal crack resistance and hydrolytic stability.

Table 10 summarizes the results of latency measurements and mechanical properties of both COMP5 and INV5.

TABLE 10
Properties of COMP5 and INV2

| | | |
|---|---|---|
| Properties | COMP5 | INV5 |

| | | | |
|---|---|---|---|
| % Viscosity increase | 25° C., 8 days | 1.1% | 2.4% |
| after storage | 40° C., 8 days | 1.3% | 0.2% |

| | | Test | | |
|---|---|---|---|---|
| Processing properties | unit | method | | |
| Viscosity @25° C. | MPa | ASTM D | 2.825 | 3.054 |
| Viscosity @25° C. | | 2196-05 | 2.857 | 3.127 |
| after 25° C./8 days | | | | |
| Viscosity increase | % | | 1.13 | 2.39 |
| after 25° C./8 days | | | | |
| Viscosity @40° C. | MPa | | 496 | 542 |
| Viscosity @40° C. | | | 502.4 | 543 |
| after 40° C./8 days | | | | |
| Viscosity increase | % | | 1.29 | 0.11 |
| after 40° C./8 days | | | | |
| Gel time | minutes | DIN | | |
| @ 100° C. | | 16945 | 11:29 | 103:51 |
| @ 140° C. | | | 2:00 | 3:02 |

| Performance Property | | Test | | |
|---|---|---|---|---|
| of cured system | unit | method | COMP5 | INV5 |
| Water Absorption, | % | ISO 62 | 0.1 | 0.06 |
| 25° C./24 hours | | | | |
| Flexural strength | MPa | ISO 178 | 98.03 | 103.66 |
| Elongation at break | % | | 3.736 | 3.849 |
| E-modulus | MPa | | 3.077 | 3.121 |
| Dielectric strength | kV/mm | IEC | 22.2 | 18.72 |
| | | 60243 | | |
| Pressure cooker test | | | Cracks | No |
| (PCT) at 120° C./ | | | seen | Cracks |
| 2 mbar/96 hrs | | | | seen |
| (Thickness 2 mm) | | | | |

### Example 6: Comparison of Exemplary Epoxy System with Epoxy System Prepared without Toughener

An exemplary epoxy system (INV6) was prepared by mixing the epoxy component, toughener, catalyst and co-catalyst. A conventional epoxy system (COMP6) was prepared by mixing the epoxy component, catalyst and co-catalyst. Table 11 provides the composition of INV6 and COMP6.

TABLE 11
Composition of INV6 and COMP6

| Composition (weight, in grams) | COMP6 | INV6 |
|---|---|---|
| Bisphenol A diglycidyl ether, and bisphenol F | 99 | 99 |
| diglycidyl ether (1:1) | | |
| Polycaprolactone-polysiloxane Block Copolymer | — | 1 |
| IOC-8 SbF₆ | 0.4 | 0.4 |
| Benzopinacol | 0.6 | 0.6 |
| Total weight of formulation | 100 | 101 |

INV6 and COMP6 were cured under curing condition: 100° C./2 hours+120° C./2 hours+140° C./10 hours.

The latency of INV6 and COMP6 was measured. Also, the mechanical properties of the cured samples of INV6 and COMP6 were assessed.

Results and Observation: It was observed that INV6 exhibited low viscosity build up, as compared to COMP6.

FIG. 6 shows a comparison of cured matrix of COMP6 (6A) and INV6 (6B), after hydrolytic stability pressure cooker test at 96 hours, 2 bar/120° C. It was observed that cured matrix COMP6 had a lot of micro-cracks, whereas cured matrix of INV6 did not have micro-cracks and exhibited improved thermal crack resistance and hydrolytic stability. Additionally, INV6 was found to exhibit improved mechanical properties as compared to COMP6.

Table 12 summarizes the results of latency measurements and mechanical properties of both INV6 and COMP6.

TABLE 12
Properties of COMP6 and INV6

| | | |
|---|---|---|
| Properties | COMP6 | INV6 |

| | | | |
|---|---|---|---|
| % Viscosity increase | 25° C., 8 days | 0.8% | 1.2% |
| after storage | 40° C., 8 days | 4.3% | 3.8% |

| | | Test | | |
|---|---|---|---|---|
| Processing properties | unit | method | | |
| Viscosity @25° C. | MPa | ASTM D | 4.012 | 4.396 |
| Viscosity @25° C. | | 2196-05 | 4.044 | 4.449 |
| after 25° C./8 days | | | | |
| Viscosity increase | % | | 0.80 | 1.20 |
| after 25° C./8 days | | | | |
| Viscosity @40° C. | MPa | | 669 | 715 |
| Viscosity @40° C. | | | 698 | 742 |
| after 40° C./8 days | | | | |
| Viscosity increase | % | | 4.33 | 3.78 |
| after 40° C./8 days | | | | |
| Gel time | minutes | DIN | | |
| @ 100° C. | | 16945 | 12:56 | 154:11 |
| @ 140° C. | | | 2:08 | 4:21 |

| Performance Property | | Test | | |
|---|---|---|---|---|
| of cured system* | unit | method | COMP6 | INV6 |
| Water Absorption, | % | ISO 62 | 0.11 | 0.05 |
| 25° C./24 hours | | | | |
| Flexural strength | MPa | ISO 178 | 94.61 | 102.81 |
| Elongation at break | % | | 3.3672 | 3.569 |
| E-modulus | MPa | | 3.107 | 3.257 |
| Dielectric strength | kV/mm | IEC | 22.18 | 20.12 |
| | | 60243 | | |
| Pressure cooker test | | | Cracks | No |
| (PCT) at 120° C./ | | | seen | Cracks |
| 2 mbar/96 hrs | | | | seen |
| (Thickness 2 mm) | | | | |

### INDUSTRIAL APPLICATION

The disclosed thermally curable epoxy system is anhydride free and complies with regulatory requirement of SVHC by REACH.

The disclosed thermally curable epoxy system exhibits an improved thermal crack resistance and improved hydrolytic stability as compared to conventional epoxy systems. Also, the disclosed thermally curable epoxy system exhibits low viscosity build-up during processing, and provides longer working time.

The disclosed thermally curable epoxy system is a 1K epoxy system. Using a single component system eliminates any chances of mixing error or mixing ratio variation.

The disclosed thermally curable epoxy system finds specific application as insulating material for trickle impregnation process to manufacture air core reactors. Additionally, the disclosed thermally curable epoxy system finds application in manufacturing electrical insulating components by casting, potting and encapsulation processes.

We claim:

1. A thermally curable epoxy system comprising:
94 to 99.98 wt % of an epoxide component;
0.01 to 5% wt% of a toughener;
0.005 to 1.5 wt % of a catalyst; and
0.005 to 1.5 wt % of a co-catalyst.

2. The thermally curable epoxy system as claimed in claim 1, wherein the epoxide component is a di- or poly-epoxide compound comprising a moiety selected from the group consisting of aliphatic, cycloaliphatic, and aromatic group.

3. The thermally curable epoxy system as claimed in claim 2, wherein the epoxide component is selected from the group consisting of bisphenol A diglycidyl ether, bisphenol F diglycidyl ether, phenol novolac epoxy resin, cyclohexanedimethanol diglycidyl ether, neopentyl glycol diglycidyl ether, dipropylene glycol diglycidyl ether, 3,4-epoxycyclohexylmethyl 3,4-epoxycyclohexane carboxylate and combinations thereof.

4. The thermally curable epoxy system as claimed in claim 1, wherein the toughener is a linear block copolymer having formula 1:
$${A}^{″} - B - {A}^{′} \qquad ( 1 )$$
wherein,
B is an organosiloxane block, and
A′ or A″ is a polycaprolactone block.

5. The thermally curable epoxy system as claimed in claim 1, wherein the catalyst is an aromatic iodonium salt of fluorometallate anions, the fluorometallate anions selected from the group consisting of (SbF₆)⁻, (BF₄)⁻, (PF₆)⁻ and (AsF₆)⁻.

6. The thermally curable epoxy system as claimed in claim 5, wherein the catalyst is selected from the group consisting of (4-octyloxyphenyl) (phenyl) iodonium hexafluoroantimonate (IOC-8 SbF₆), (4-isopropylphenyl)-(p-tolyl) iodonium tetrakis (perfluorophenyl) borate (IPTI-PFPB), diphenyliodonium tetrafluoroborate and diphenyliodonium hexafluorophosphate.

7. The thermally curable epoxy system as claimed in claim 1, wherein the co-catalyst is benzopinacol or a derivative thereof.

8. The thermally curable epoxy system as claimed in claim 7, wherein the benzopinacol derivative is selected from the group consisting of benzopinacolone, benzopinacol-bis (trimethylsilyl ether), benzopinacol dimethyl ether, 1,1,2,2-tetraphenylethane and combinations thereof.

9. The thermally curable epoxy system as claimed in claim 1, wherein the thermally curable epoxy system is a 1K epoxy system.

10. An insulating material comprising the thermally curable epoxy system as claimed in claim 1.

11. A hydrolytically stable and crack resistant thermally curable 1k epoxy system as claimed in claim 1.
